(19) United States
(12) Patent Application Publication
(10) Pub. No.: US 2020/0236465 A1
(43) Pub. Date: Jul. 23, 2020

(54) METHOD FOR CONTROLLING AUDIO DEVICE AND ASSOCIATED CONTROL CIRCUIT

(71) Applicant: Realtek Semiconductor Corp., Hsinchu (TW)

(72) Inventors: ZHAOMING LI, Suzhou City (CN); Zuohui Peng, Suzhou City (CN)

(21) Appl. No.: 16/729,466

(22) Filed: Dec. 29, 2019

(30) Foreign Application Priority Data
Jan. 23, 2019 (CN) 201910064746.1

(51) Int. Cl. H04R 5/033; H04R 1/10; H04R 3/00; H04W 52/02

(52) U.S. Cl. CPC H04R 5/033; H04R 1/1033; H04R 2420/07; H04W 52/0238; H04R 3/00

(57) ABSTRACT

The present invention provides a method for controlling an audio device, wherein the method includes the steps of: controlling an electronic device to use a first wireless communication module to communicate with the audio device; controlling the electronic device to perform burst transmission to transmit audio data to the audio device during a partial time of a time period only; controlling the audio device to continuously play the audio data during the time period; and when the audio device finishes receiving the audio data, controlling a second wireless communication module of the audio device to enter a sleep mode.

### BACKGROUND OF THE INVENTION

### 1. Field of the Invention

The present invention is related to wireless communications, and more particularly, to a method for controlling an electronic device to enter a sleep mode through wireless communications.

### 2. Description of the Prior Art

Current wireless earphones mostly utilize BlueTooth for transmitting audio data. Since a BlueTooth earphone only requires a small current when receiving and playing audio data, usage time of a battery can be increased. A disadvantage of the BlueTooth earphone is that its throughput is too low, so that the BlueTooth earphone cannot be utilized for transmission of high-quality music with minimum distortion.

In comparison with BlueTooth, Wireless Fidelity (Wi-Fi) communications can reach a high throughput (e.g. in the 802.11g specification, the highest throughput can reach 54 megabits per seconds (Mbps)), and is therefore suitable for transmitting high-quality and non-distortion music. The application of Wi-Fi communications to wireless earphones is limited, however, since power consumption of Wi-Fi communications is much greater than BlueTooth. Additionally, the 802.11 specification states that turning off Wi-Fi communication mechanism and entering a power-saving/sleep mode is determined according to a current data amount. Since entering the power-saving/sleep mode only depends on the data amount in conventional Wi-Fi power-saving mechanisms, the start time point and the end time point of data transmission are unpredictable. Power-saving effect is therefore not good in practice, and the throughput might be affected.

### SUMMARY OF THE INVENTION

Thus, an objective of the present invention is to provide a method for controlling an electronic device to enter a sleep mode through wireless communications, wherein the method can precisely control a wireless communication module within a wireless earphone to operate in a normal mode or sleep mode in order to save power, and the throughput and normal operations of the earphone will not be affected.

In an embodiment of the present invention, a control circuit for an electronic device is disclosed. The electronic device comprises a wireless communication module configured to perform wireless communication with another electronic device; and the control circuit performs burst transmission using the wireless communication module to transmit data to the other electronic device during a partial time of a time period only, and the data is configured for being continuously played by the other electronic device during the time period.

In another embodiment of the present invention, a control circuit for an electronic device is disclosed. The electronic device comprises a wireless communication module configured to perform wireless communication with another electronic device, and a playing component. The control circuit is configured to use the wireless communication module to receive data from the other electronic device, wherein the playing component continuously plays the data during a time period, the control circuit receives the data during a partial time of the time period only, and the control circuit controls the wireless communication module to operate in a sleep mode or a normal mode according to the partial time.

In another embodiment of the present invention, a method for controlling an audio device is disclosed. The method comprises the following steps: controlling an electronic device to use a first wireless communication module to communicate with the audio device; controlling the electronic device to perform burst transmission to transmit audio data to the audio device during a partial time of a time period only; controlling the audio device to continuously play the audio data during the time period; and when the audio device finishes receiving the audio data, controlling a second wireless communication module of the audio device to enter a sleep mode.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a data transmission system according to an embodiment of the present invention.

FIG. 2 is a flowchart illustrating a method for controlling an audio device according to an embodiment of the present invention.

FIG. 3 is a timing diagram illustrating a method for controlling an audio device according to an embodiment of the present invention.

FIG. 4 is a flowchart illustrating a method for controlling an audio device according to another embodiment of the present invention.

FIG. 5 is a timing diagram illustrating a method for controlling an audio device according to another embodiment of the present invention.

### DETAILED DESCRIPTION

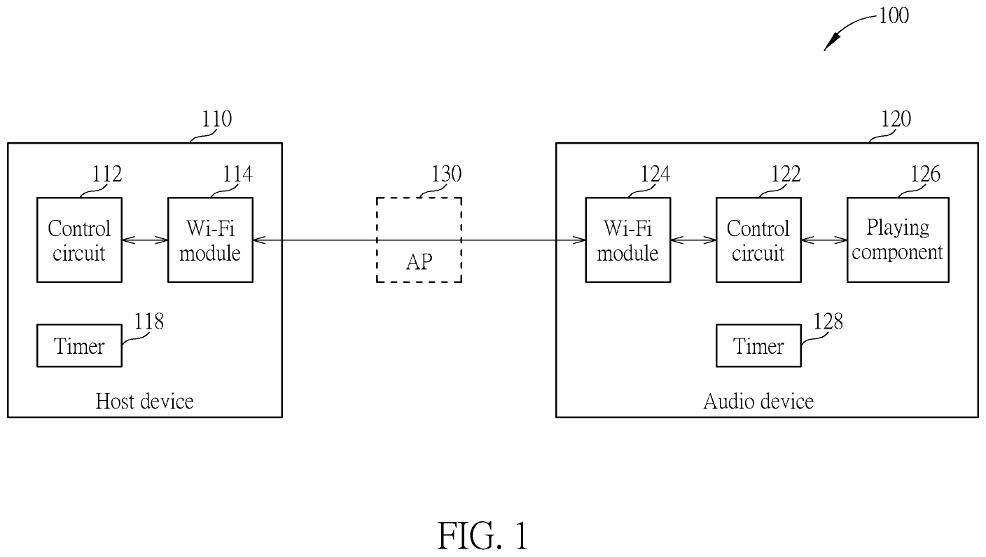

FIG. 1 is a diagram illustrating a data transmission system 100 according to an embodiment of the present invention. As shown in FIG. 1, the data transmission system 100 comprises two electronic devices (indicated by a host device 110 and an audio device 120 in this embodiment), and the host device 110 and the audio device 120 may directly perform wireless communication or perform wireless communication with each other through an access point (AP) 130. The host device 110 comprises a control circuit 112, a Wi-Fi module 114 and a timer 118, where the control circuit 112 may comprise related circuits configured for processing audio data and controlling the Wi-Fi module 114, and may be implemented by hardware circuits or application programs executed by a processor. The audio device 120 comprises a control circuit 122, a Wi-Fi module 124, a playing component 126 and a timer 128, where the control circuit 122 may comprise related circuits configured for processing audio data, transmitting audio data to the playing component 126 for playing and controlling the Wi-Fi module 124, and may be implemented by hardware circuits or application programs executed by a processor. Additionally, those skilled in this art should understand that the Wi-Fi module 114 and the Wi-Fi module 124 may be replaced with other wireless communication modules according to requirements: for example, wireless communication modules such as Near-field communications (NFC), Radio Frequency Identification (RFID), infrared communications, Bluetooth and ZigBee, but the present invention is not limited thereto.

In an embodiment, the host device 110 may be a smart phone, a tablet, a notebook computer, or any electronic device that is able to transmit data to the audio device 120, and the audio device 120 maybe a wireless earphone, a wireless sound box, or any audio playing device having a loudspeaker.

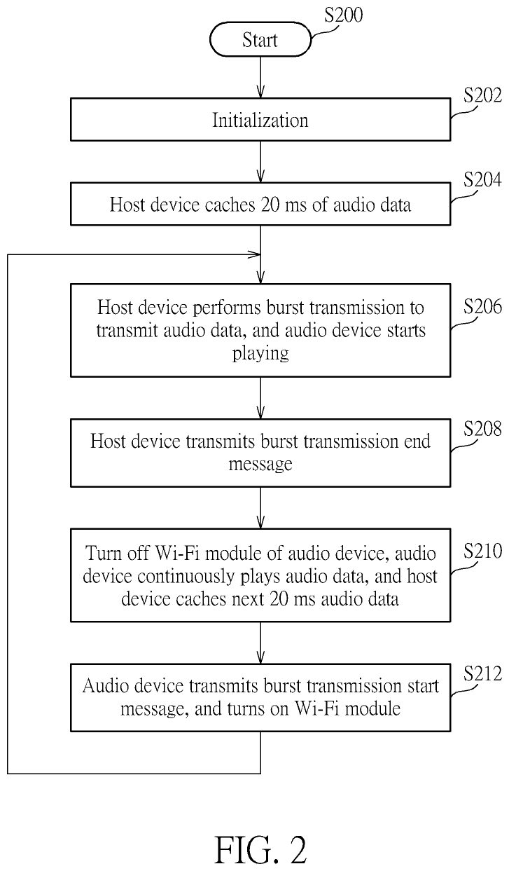

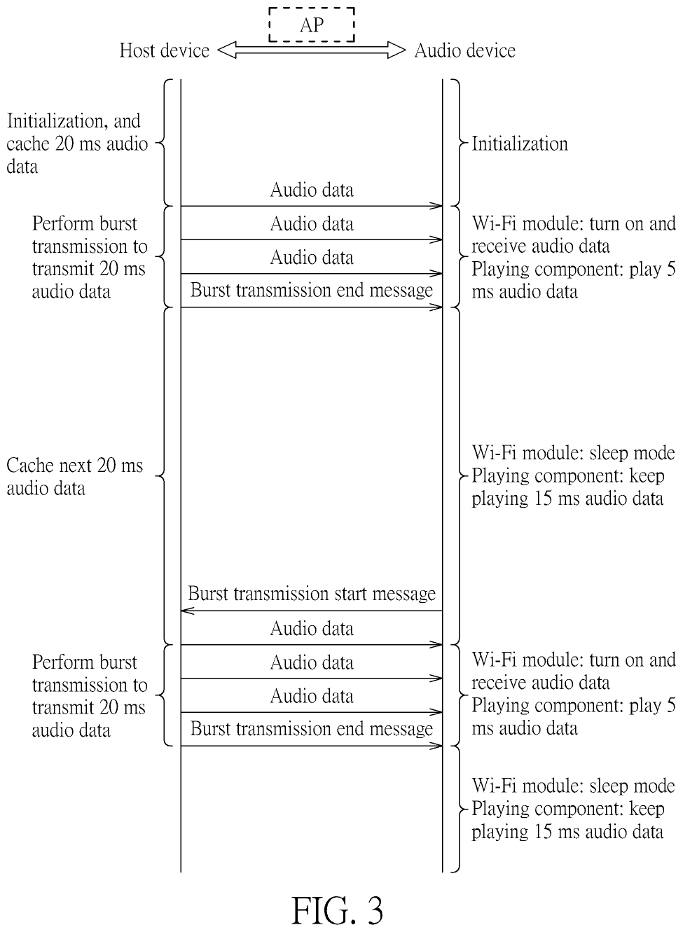

Refer to FIG. 2 and FIG. 3 together, where FIG. 2 is a flowchart illustrating a method for controlling an audio device according to an embodiment of the present invention, and FIG. 3 is a timing diagram of a method for controlling an audio device according to an embodiment of the present invention. In Step S200, the flow starts, and the host device 110 and the audio device 120 establish a connection. In Step S202, the control circuit 122 and the Wi-Fi module 124 within the audio device 120 perform initialization. In Step S204, the host device 110 caches audio data for being played during a time period in a memory (not shown) of the host device 110. This embodiment assumes that the host device 110 caches 20 milliseconds (ms) of audio data. In Step S206, the control circuit 112 within the host device 110 performs burst transmission (e.g. uses a burst transmission method) using the Wi-Fi module 114 to immediately transmit the 20 ms audio data to the audio device 120 within a shorter time. This embodiment assumes that the host device 110 transmits the 20 ms audio data to the audio device 120 within 5 ms, wherein when the audio device 120 starts receiving the audio data, the audio device 120 plays contents of the received audio data through the playing component 126. In Step S208, when the host device 110 finishes transmitting the 20 ms audio data, the host device 110 transmits a burst transmission end message to the audio device 120. In Step S210, after the audio device receives the burst transmission end message from the host device 110, the control circuit 122 may turn off the Wi-Fi module 124 or set the Wi-Fi module 124 to be in a sleep mode in order to save power. At this moment, the control circuit 122 is still continuously playing the remaining portion of the previously received 20 ms audio data (in this embodiment, the remaining 15 ms); concurrently, the host device 110 may turn off the Wi-Fi module 114 or set the Wi-Fi module 114 to be in a sleep mode to save power, and start to cache the next 20 ms audio data. In Step S212, when the control circuit 122 of the audio device 120 detects that playing time of the previously received 20 ms audio data is going to end (e.g. only 3 to 4 ms of audio data remain for playing), the control circuit 122 may turn on the Wi-Fi module 124 or set the Wi-Fi module 124 to be in a normal mode, and transmit a burst transmission start message to the host device 110 in order to trigger the host device 110 to start performing burst transmission for transmitting the next 20 ms audio data (the flow returns to the Step S206).

As mentioned in the flowchart shown in FIG. 2 and the timing diagram shown in FIG. 3, since the host device 110 uses the burst transmission method to finish transmitting the 20 ms audio data within 5 ms, the Wi-Fi module 124 of the audio device 120 can enter the sleep mode for the remaining time in order to save power. Additionally, since the playing component 126 can still play the audio data when the Wi-Fi module 124 is in the sleep mode, the user experience will not be affected. Further, since the host device 110 may transmit the burst transmission end message after the burst transmission ends, and wake-up time of the audio device 120 is determined according to the remaining audio data itself without a need for being triggered by a message from the host device 110, the audio device can precisely know the start time point and the end time point of the host device 110 performing burst transmission, so that power-saving control of the Wi-Fi module 124 can be more efficient.

In an embodiment, since a lost packet may occur during wireless transmission, the audio device 120 may utilize information of the timer 128 to determine whether the burst transmission end message from the host device is lost. For example, according to a time message provided by the timer 128, and assuming that the audio device 120 does not receive any burst transmission end message for a period of time (e.g. 7 ms) after the audio device 120 starts receiving the audio data, the control circuit 122 may determine that the burst transmission end message is lost, and will thereby turn off the Wi-Fi module 124 or set the Wi-Fi module 124 to be in sleep mode in order to save power. In addition, the host device 110 may utilize information of the timer 118 to determine whether a burst transmission start message from the audio device 120 is lost. For example, according to a time message provided by the timer 118, and assuming that the host device 110 does not receive any burst transmission start message for a period of time (e.g. 18 ms) after the host device 110 starts transmitting the audio data, the control circuit 112 may determine that the burst transmission start message is lost, and thereby directly starts to transmit the next audio data.

It should be noted that the aforementioned transmission of the 20 ms audio data within 5 ms, as well as other related numbers and parameters, are for illustrative purposes only and are not a limitation of the present invention. In other embodiments, if the speed of Wi-Fi transmission is faster or the audio data utilizes a lower sampling rate, the host device can use a shorter time to transmit the audio data, so that a power-saving duration of the Wi-Fi module 124 within the audio device 120 can be longer.

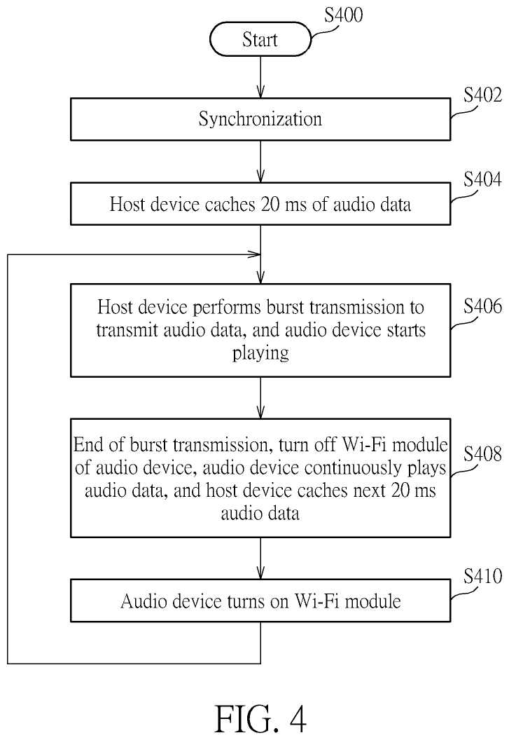

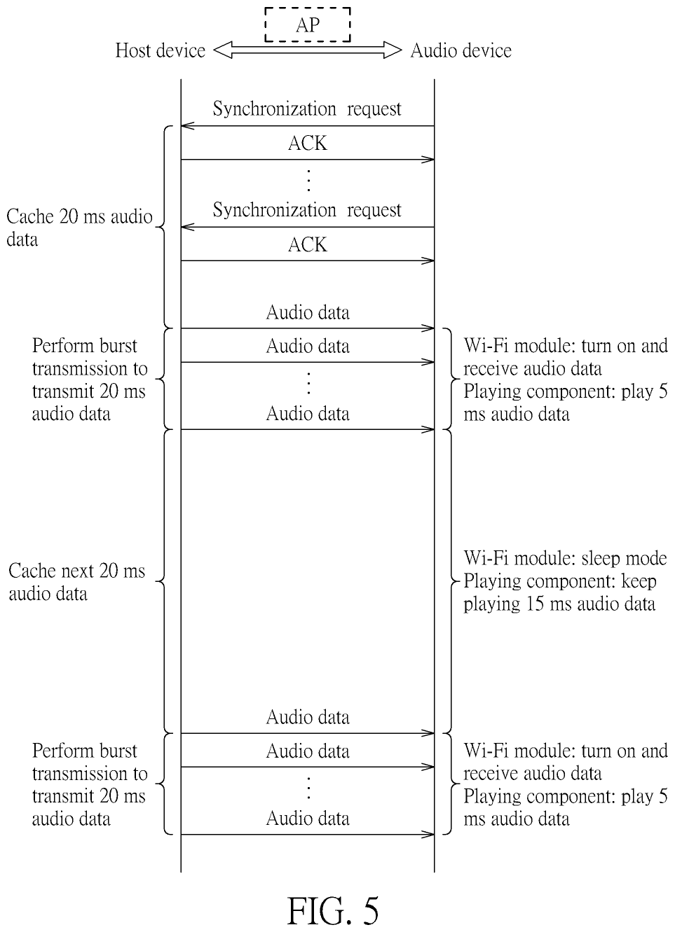

Refer to FIG. 4 and FIG. 5 together, where FIG. 4 is a flowchart illustrating a method for controlling an audio device according to an embodiment of the present invention, and FIG. 5 is a timing diagram illustrating a method for controlling an audio device according to an embodiment of the present invention. In Step S400, the flow starts, and the host device 110 and the audio device 120 establish a connection and perform initialization. In Step S402, the host device 110 and the audio device 120 perform synchronization (e.g. time synchronization) in order to make the host device 110 and the audio device 120 have an absolute synchronized time. More specifically, in a first example of synchronization, the audio device 120 may transmit a synchronization request (e.g. a current time stamp DeviceTsf1 of the audio device 120) to the host device 110; the host device 110 returns a confirmation message ACK to the audio device 120 after receiving the synchronization request and, at this moment, the host device 110 utilizes the time stamp DeviceTsf1 from the audio device 120 to update/synchronize time of the host device 110; after the audio device 120 receives the confirmation message ACK, the audio device 120 calculates a difference between a current time stamp DeviceTsf2 and the previous time stamp DeviceTsf1; if the calculated difference is less than a threshold value, the synchronization succeeds, and if the calculated difference is greater than the threshold value, the aforementioned step is repeated to perform synchronization; if asynchronous time happens after a period of time, synchronization may be performed during a power-off time of the Wi-Fi module 124 (e.g. when the Wi-Fi module 124 is turned off or the Wi-Fi module 124 enters the sleep mode). In a second example of synchronization, if the host device 110 and the audio device 120 perform data transmission through the AP 130, the host device 110 and the audio device 120 may directly utilize the time of the AP 130 to perform synchronization. It should be noted that the aforementioned two steps of synchronization are illustrated as examples but not limitations of the present invention.

In Step S404, the host device 110 caches audio data in a memory of the host device 110 for being played during a time period. This embodiment assumes that the host device 110 caches 20 milliseconds (ms) of audio data. In Step S406, the control circuit 112 within the host device 110 performs burst transmission (e.g. uses a burst transmission method) using the Wi-Fi module 114 for immediately transmitting the 20 ms audio data to the audio device 120 within a shorter time. This embodiment assumes that the host device 110 transmits the 20 ms audio data to the audio device 120 within 5 ms, wherein when the audio device 120 starts receiving the audio data, the audio device 120 plays contents of the received audio data through the playing component 126. In this embodiment, the burst transmission transmits multiple packets to the audio device 120 at once, and in an example, each packet within the multiple packets may comprise the following four parameters: a burst transmission start time (BurstStartTsf), playing time of burst transmission of the audio data (BurstPeriod), a number of the multiple packets of burst transmission (BurstPacketNum), and a packet serial number (DataSeq).

In Step S408, the audio device 120 may determine whether burst transmission of the host device 110 ends according to parameters within each packet. For example, assuming that the burst transmission transmits five packets (BurstPacketNum=5) having respective packet serial numbers 0 to 4, when the audio device 120 receives a packet having the packet serial number DataSeq=4, the audio device 120 may determine that the burst transmission ends in order to turn off the Wi-Fi module 124 or control the Wi-Fi module 124 to enter the sleep mode. Regarding a time for turning off the Wi-Fi module 124 or controlling the Wi-Fi module to enter the sleep mode, the following equation can be utilized:

OffTime=BurstPeriod−(DeviceTsf−BurstStartTsf)−Delta;

where DeviceTsf is the time of the audio device 120, Delta is a deviation value to guarantee that the Wi-Fi module 124 will be in the normal mode or turned on before the host device 110 transmits next information data.

Additionally, after the host device 110 finishes transmitting the last packet, the host device 110 may stop transmitting audio data for a period of time, where the period of time that transmission of audio data is stopped can be calculated utilizing the following equation:

IdelTime=BurstPeriod−(HostTsf−BurstStartTsf);

where HostTsf is the time of the host device 110; concurrently, the host device may turn off the Wi-Fi module 114 or set the Wi-Fi module 114 to be in the sleep mode in order to save power, and start to cache the next 20 ms audio data.

In Step S410, when the Wi-Fi module 124 has entered the sleep mode for a period of time, and the period of time has reached the previously calculated off-time, the control circuit 122 may turn on the Wi-Fi module 124 or set the Wi-Fi module 124 to be in the normal mode to start receiving the next audio data from the host device 110 (the flow returns to Step S408).

As mentioned in the flowchart shown in FIG. 4 and the timing diagram shown in FIG. 5, since the host device 110 uses the burst transmission method to finish transmitting the 20 ms audio data within 5 ms, the Wi-Fi module 124 of the audio device 120 can enter the sleep mode in the remaining time to save power, and the playing component 126 can still play the audio data when the Wi-Fi module 124 is in the sleep mode, so that a user experience will not be affected. In addition, a synchronization mechanism is utilized, which means the host device 110 and the audio device 120 are less affected by lost packet(s) during the operations, so that stability of the system is further enhanced. In addition, since the host device 110 may precisely know the start time point and the end time point of the host device 110 performing burst transmission, so that power-saving control of the Wi-Fi module 124 can be more efficient.

It should be noted that, although embodiments of FIG. 1 to FIG. 5 are illustrated with reference to the audio device 120, but the present invention is not limited to audio data transmission. In other embodiments of the present invention, the audio device 120 can be replaced with any electronic device that needs to receive continuous data for playback; for example, the host device 110 can perform burst transmission to transmit image data, and the audio device can be replaced with an image display device. These modified designs also belong to the present invention.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A control circuit for an electronic device, wherein the electronic device comprises a wireless communication module configured to perform wireless communication with another electronic device; and the control circuit performs burst transmission using the wireless communication module to transmit data to the other electronic device during a partial time of a time period only, and the data is configured for being continuously played by the other electronic device during the time period.

2. The control circuit of claim 1, wherein the control circuit uses the wireless communication module to immediately transmit a burst transmission end message to the other electronic device after finishing transmitting the data, and the control circuit does not transmit other data to the other electronic device after transmitting the burst transmission end message during the time period.

3. The control circuit of claim 1, wherein the control circuit uses the wireless communication module to transmit next data to the other electronic device only after receiving a burst transmission start message from the other electronic device or when time of a timer within the electronic device reaches a threshold value.

4. The control circuit of claim 1, wherein the control circuit further uses the wireless communication module to perform synchronization with the other electronic device, and the data transmitted by the control circuit to the other electronic device comprises time of the data starts to be transmitted, playing time of the data, and information for determining end of the data.

5. The control circuit of claim 4, wherein the data comprises multiple packets, and each packet within the multiple packets comprises the time of the data starts to be transmitted, the playing time of the data, a number of the multiple packets and a packet serial number.

6. The control circuit of claim 1, wherein the data is audio data, the other electronic device is an audio device, and the wireless communication module is a Wireless Fidelity (Wi-Fi) communication module.

7. A control circuit for an electronic device, wherein the electronic device comprises a wireless communication module configured to perform wireless communication with another electronic device, and a playing component; the control circuit is configured to use the wireless communication module to receive data from the other electronic device, the playing component continuously plays the data during a time period, the control circuit receives the data during a partial time of the time period only, and the control circuit controls the wireless communication module to operate in a sleep mode or a normal mode according to the partial time.

8. The control circuit of claim 7, wherein when the control circuit uses the wireless communication module to receive a burst transmission end message after receiving the data, the control circuit controls the wireless communication module to enter the sleep mode.

9. The control circuit of claim 8, wherein when the wireless communication module has entered the sleep mode for a predetermined time, or when playing time of the data almost ends, the control circuit uses the wireless communication module to transmit a burst transmission start message to the other electronic device in order to inform the other electronic device to transmit next data.

10. The control circuit of claim 7, wherein the control circuit further uses the wireless communication module to perform synchronization with the other electronic device, and the data comprises time of the data starts to be transmitted, playing time of the data, and information for determining end of the data, in order to control time of the wireless communication module entering the sleep mode.

11. The control circuit of claim 10, wherein the data comprises multiple packets, and each packet within the multiple packets comprises the time of the data starts to be transmitted, the playing time of the data, a number of the multiple packets and a packet serial number; and the control circuit controls the time of the wireless communication module entering the sleep mode according to the time of the data starts to be transmitted, the playing time of the data, the number of the multiple packets and the packet serial number within said each packet.

12. The control circuit of claim 7, wherein the data is audio data, the other electronic device is an audio device, and the wireless communication module is a Wireless Fidelity (Wi-Fi) communication module.

13. A method for controlling an audio device, comprising:
controlling an electronic device to use a first wireless communication module to communicate with the audio device;
controlling the electronic device to perform burst transmission to transmit audio data to the audio device during a partial time of a time period only;
controlling the audio device to continuously play the audio data during the time period; and
when the audio device finishes receiving the audio data, controlling a second wireless communication module of the audio device to enter a sleep mode.

14. The method of claim 13, further comprising:
controlling the electronic device to immediately transmit a burst transmission end message to the audio device after finishing transmitting the audio data; and
when the audio device receives the burst transmission end message, controlling the second wireless communication module to enter the sleep mode.

15. The method of claim 14, further comprising:
when the second wireless communication module of the audio device has entered the sleep mode for a predetermined time, or when playing time of the audio data almost ends, controlling the audio device to transmit a burst transmission start message to the electronic device;
when the electronic device receives the burst transmission start message, or when time of a timer within the electronic device reaches a threshold value, controlling the electronic device to transmit next audio data to the audio device.

16. The method of claim 13, further comprising: controlling the audio device to further use the second wireless communication module to perform synchronization with the electronic device, and the audio data comprises time of the audio data starts to be transmitted, playing time of the audio data, and information for determining end of the audio data; and controlling the audio device to control time of the second wireless communication module entering the sleep mode according to the time of the audio data starts to be transmitted, the playing time of the audio data, and the information for determining the end of the audio data.

17. The method of claim 16, wherein the audio data comprises multiple packets, and each packet within the multiple packets comprises the time of the audio data starts to be transmitted, the playing time of the audio data, a number of the multiple packets and a packet serial number; and controlling the audio device to control the time of the second wireless communication module entering the sleep mode according to the time of the audio data starts to be transmitted, the playing time of the audio data, the number of the multiple packets and the packet serial number within said each packet.

18. The method of claim 13, wherein the first wireless communication module and the second wireless communication module are Wireless Fidelity (Wi-Fi) communication modules.
